(19) United States
(12) Patent Application Publication
(10) Pub. No.: US 2019/0212228 A1
(43) Pub. Date: Jul. 11, 2019

(54) TOOTHING TEST STAND

(71) Applicants: ZF FRIEDRICHSHAFEN AG, Friedrichshafen (DE); ZF WIND POWER ANTWERPEN N.V., Lommel (BE)

(72) Inventor: Dirk Leimann, Edegem (BE)

(21) Appl. No.: 16/324,153

(22) PCT Filed: Jul. 10, 2017
(86) PCT No.: PCT/EP2017/067274

§ 371 Date: Feb. 8, 2019

(30) Foreign Application Priority Data
Aug. 8, 2016 (DE) 10 2016 214 646.7

(51) Int. Cl. G01M 13/025

(52) U.S. Cl. CPC G01M 13/025; G01M 13/021

(57) ABSTRACT

A toothing test stand includes a sample holder and a load generator. The load generator has at least one head, and the sample holder is designed to hold at least one part of a single tooth sample separated from toothing of a gear wheel. The tooth sample comprises a tooth of the gear wheel, and the head of the load generator bears against a flank of the tooth and applies a load to the flank. The head of the load generator is rotatably mounted, and an axis of rotation of the head of the load generator, starting from a course that runs parallel to a flank line of the flank of the tooth, rotates about a surface normal of a contact surface of the head of the load generator and the flank of the tooth.

### CROSS REFERENCE TO RELATED APPLICATIONS

This application is a U.S. National Stage Application under 35 U.S.C. § 371 of International Application No. PCT/EP2017/067274 filed on Jul. 10, 2017, and claims benefit to German Patent Application No. DE 10 2016 214 646.7 filed on Aug. 8, 2016. The International Application was published in German on Feb. 15, 2018, as WO 2018/028910 A1 under PCT Article 21(2).

### FIELD

The invention relates to a toothing test stand for testing the toothing of a gear wheel, a tooth sample, and a method for testing the toothing of a gear wheel.

### BACKGROUND

To check the strength of the toothing of a gear wheel, the prior art offers what are known as FZG test stands and pulsator test stands. In an FZG test stand, the teeth of two gear wheels are engaged and braced against one another. The gear wheels are usually small-scale models of larger gear wheels. This involves the risk that the results determined cannot be translated 1:1 to the larger gear wheels. In addition, in the case of an FZG test stand, the bracing, and thus the simulated load, is usually static. The testing of dynamic loads is therefore not possible.

In a pulsator test stand, two teeth of the toothing of a gear wheel are braced between two punches. Dynamic loads can be applied by means of the punches. However, due to the deformations in the gear wheel, the bearing surface of the punch on the teeth is not precisely defined. Moreover, it is not possible to simulate the roll-off movements of the individual teeth occurring in involute toothing. Also, it is not possible to test obliquely-toothed gear wheels using conventional pulsator testing stands. The direction of the forces introduced to the gear wheel by the punches is orthogonal to an axis of rotation of the gear wheel. This requires straight teeth.

### SUMMARY

In an embodiment, the present invention provides a toothing test stand. The toothing test stand including a sample holder and a load generator. The load generator has at least one head, and the sample holder is designed to hold at least one part of a single tooth sample separated from toothing of a gear wheel. The tooth sample comprises a tooth of the gear wheel, and the head of the load generator bears against a flank of the tooth and applies a load to the flank. The head of the load generator is rotatably mounted, and an axis of rotation of the head of the load generator, starting from a course that runs parallel to a flank line of the flank of the tooth, rotates about a surface normal of a contact surface of the head of the load generator and the flank of the tooth.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 depicts a pulsator test stand known from the prior art;

FIG. 2 depicts a toothing test stand with the features of an embodiment of the invention;

FIG. 3 depicts a partial view of a clamped tooth sample;

FIG. 4 depicts testing of a tooth sample using a load generator;

FIG. 5 depicts specific sliding;

FIGS. 6a and 6b depict forces in specific sliding;

FIG. 7 depicts a test cycle;

FIG. 8 depicts a two-headed toothing test stand;

FIG. 9 depicts specific sliding in the two-headed toothing test stand;

FIG. 10 depicts a gear wheel with outer toothing; and

FIG. 11 depicts a gear wheel with inner toothing.

### DETAILED DESCRIPTION

Embodiments of the invention provide for checking a load behavior of the toothing of a gear wheel while avoiding disadvantages inherent in solutions known from the prior art. In particular, embodiments of the invention provide test results having improved validity.

A toothing test stand is an arrangement for testing the toothing of a gear wheel. A toothing test stand according to an embodiment of the invention comprises a sample holder, i.e., a means for holding a sample or a test piece, and a load generator, i.e., a means for applying a load, e.g. a mechanical load. The load generator has at least one head for transmitting the load to the sample. The sample is a tooth sample. This comprises, preferably, exactly one tooth detached from the teeth of the gear wheel. The gear wheel is preferably an internally or externally-toothed, cylindrical gear wheel. The toothing thereof can be designed approximately as a straight toothing, but also as involute toothing.

The sample holder is designed to hold the sample described, in other words, to suitably fix it in place. The fixing is effected in such a way that a load can be applied to one flank of the tooth.

The head of the load generator bearing against the flank of the tooth is used to apply the load. The load is introduced to the flank via a corresponding contact surface of the head on the flank.

The load is a force that manifests itself in the contact surface as pressure. In particular, the force can be variable over time.

The invention makes it possible to directly test the toothing of an actual gear wheel without needing to make miniature models. Since only a single tooth is tested, it is not necessary to clamp the gear wheel completely in the test stand. This is an advantage—especially for large gear wheels such as those in wind turbines. Also, corresponding to actual load situations, loads which vary as a function of time can be simulated.

In order to apply varying loads to the flank of the tooth by means of the head of the load generator, in a preferred embodiment, the tooth sample, including the tooth, and the head move relative to one another. Thus, according to this embodiment, the tooth sample can be moved translationally in a first direction, and the head can be moved translationally in a second direction. The movements of the tooth sample in the first direction and of the head in the second direction occur relative to a stationary structure, such as a housing of the toothing test stand. It is preferable for the tooth sample and/or the head to be fixed, approximately in the stationary structure, such that the only movements possible are those in the first direction or in the second direction.

In a further preferred embodiment, the second direction runs anti-parallel to a surface normal of a contact surface of the head and the flank. This is the same thing as saying that the second direction runs anti-parallel to a surface normal of the flank, wherein the head in the surface normal bears against the flank. This creates a requirement that the flank of the tooth be loaded by way of a first force acting on the tooth in the first direction and a second force acting on the tooth in the second direction.

The tooth sample is preferably clamped symmetrically in the tooth test stand. This means that a plane, with respect to which the tooth is in planar symmetry, and the direction of motion of the tooth sample, i.e. the first direction, are aligned parallel to one another. With respect to the gear wheel, from which the tooth sample has been separated, the first direction runs radially, i.e., orthogonally, to an axis of rotation or central axis of the gear wheel.

In preferred embodiments, the first force and the second force are applied according to the principle of action and reaction.

In a preferred embodiment, the head is thus braced against the flank. In this case, the head passively applies the second force—the reaction—in response to an actively applied first force.

In particular, the load generator can for this purpose have at least one spring element, which is braced against the head. Specifically, the spring element is braced between the head and a stationary means. The stationary means is a component of the load generator, which may be fixed in the above-mentioned stationary structure, for example.

The direction of action of the spring element preferably coincides with the second direction. Thus, the spring element results in the application of a spring force pointing in the second direction to the head. The spring force applied to the head occurs in response to a force introduced in the other direction.

In a preferred embodiment, an actuator is provided for initiating said force. According to the embodiment, the actuator acts on the tooth sample, i.e., acts on the tooth sample with an action force. The force applied to the tooth by the actuator runs in the first direction. Accordingly, the effective direction of the actuator preferably corresponds to the first direction. The actuator is preferably fixed in the stationary structure and acts on the tooth sample.

According to the embodiment, the actuator moves the tooth sample in an oscillating manner. An oscillating movement is characterized by a repeated reversal of the direction of movement. The oscillating movement of the tooth is in the first direction or opposite thereto.

The term, “oscillating movement,” is equivalent to oscillation. According to the embodiment, the actuator thus excites the tooth sample into an oscillating state.

Alternatively, the actuator of the load generator acts on the head, and not on the tooth sample. In this case, the effective direction of the actuator coincides with the second direction. The actuator is preferably fixed in the stationary structure in this case.

When the actuator acts on the head, the spring element acts correspondingly on the tooth sample. The spring element is braced between the stationary structure and the tooth sample. In this case, the effective direction of the spring element preferably coincides with the first direction, i.e., the spring force applied by the spring element points in the first direction.

In a further preferred embodiment, the head is rotationally symmetrical. In particular, the head can be designed as a cylindrical roller. This results in linear contact between the head and the flank of the tooth. Accordingly, the head applies a linear load to the head.

A rotatably-mounted embodiment of the head is particularly preferred. This allows the head to roll off the flank of the tooth. The rolling-off movement of the head corresponds to a rolling tooth engagement occurring in involute tooth systems.

An axis of rotation of the rotatably-mounted head can be interlaced with respect to at least one flank line of the tooth flank. This means that the axis of rotation and the flank line run askew relative to one another. The interlacing of the rotation axis with the flank line preferably occurs in such a way that, starting from a course which is parallel with the flank line, the axis of rotation is rotated about a surface normal of the contact surface of the head and the flank of the tooth. As a result, due to the movements of the tooth sample in the first direction and/or of the head in the second direction, the head not only rolls off along the flank of the tooth, but is also subject to a sliding movement orthogonal to the direction of rolling. In this way, a load on the flank can be simulated by so-called specific sliding.

In a particularly preferred embodiment, to simulate multiple-axis load states, the load generator has at least two heads which sit against the same flank of the tooth and which each apply a load to the flank. The first head and the second head are spatially separated from each other and contact the flank of the tooth in spatially separated contact surfaces. The loads applied by the heads to the flank of the tooth are thus also spatially separated from one another.

The use of two heads makes it possible to deliberately bring about bending stress on the tooth with one of the heads, while the other head, closer to the base of the tooth, causes a weakening of the surface of the flank of the tooth due to the compressive stress. Based thereon, the fatigue strength of the tooth can be determined, both with respect to compression and with respect to bending. Both factors are known sources of failure.

The at least two heads are each movable in a direction running anti-parallel to a surface normal of a contact surface of the respective head and flank of the tooth. It is preferable for each of the heads to be braced against the flank. Spring elements can be provided for this purpose, each being braced between the heads and the fixed structure. Alternatively, it is possible to load the heads using an actuator or to set them into an oscillating movement. Moreover, the heads are preferably rotationally symmetrical or designed as a roller, and are rotatably mounted. To simulate specific sliding, each of the rotational axes of the two heads can be interlaced with respect to at least one flank line of the flank of the tooth.

The tooth sample comprises one—preferably, exactly one—tooth of a gear wheel and a shaft for fixation in the sample holder of the toothing test stand described above. The shaft can be at least partially cuboid or cylindrical in shape. The tooth sample has been separated from the gear wheel. This implies that the tooth sample was previously a component of the gear wheel.

A method according to the invention for testing the toothing of a gear wheel comprises the following steps: detaching a tooth from the gear wheel; and testing the tooth using a toothing test stand of the type described above.

The detachment of the tooth can be carried out by sawing or disaggregation. Sawing is defined in the DIN 8589 standard. The DIN 8588 standard defines disaggregation.

The method step of testing comprises a partial step of clamping the tooth into the toothing test stand and a partial step of loading the tooth by means of the toothing test stand. The tooth is clamped in the toothing test stand, where it is fixed in the sample holder. The stress on the tooth is such that a load is applied to a flank of the tooth by the head or heads of the toothing test stand.

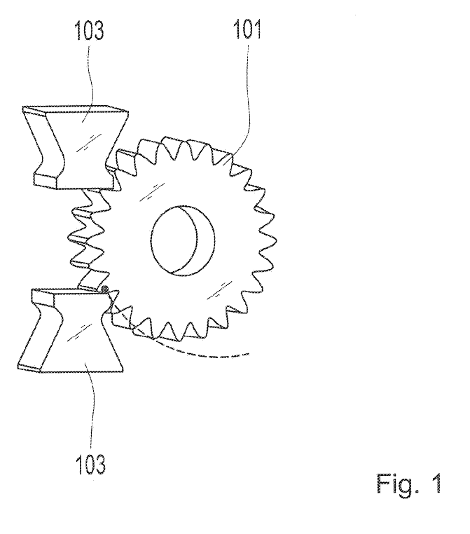

The gear wheel 101 shown in FIG. 1 is clamped between two punches 103 of a conventional pulsator test stand for purposes of simulating a dynamic load situation. The punches 103 engage in the toothing of the gear wheel 101 and apply a load.

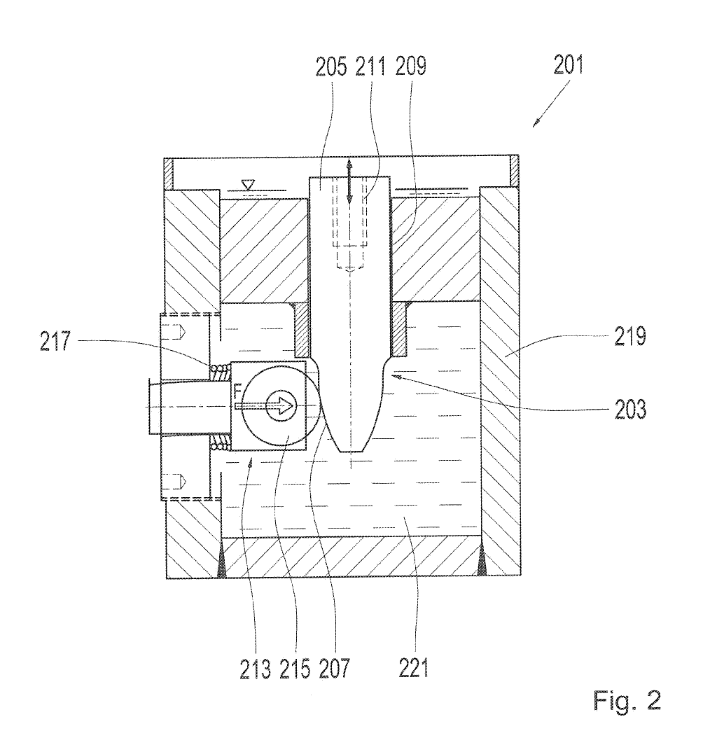

Conventional pulsator testing stands have a number of disadvantages which can be avoided with the toothing test stand 201 shown in FIG. 2. A tooth sample 203 to be tested is clamped in the toothing test stand 201. The tooth sample 203 is characterized in that it is not a model produced for purposes of testing, but was extracted from a serviceable gear wheel.

The tooth sample 203 comprises a shaft 205 and two tooth flanks 207. The tooth sample 203 is clamped by the shaft 205 in a sample holder 209. The sample holder 209 guides the tooth sample 203 in a vertical direction.

The shaft 205 has a blind bore which opens upward, the bore having an internal thread 211. Via the internal thread 211, the tooth sample 203 can be connected to an actuator (not shown in FIG. 2) which moves the tooth sample 203 up and down.

To simulate a load acting on the flank 207, the toothing test stand 201 has a load generator 213. A rotatably-mounted roller 215 of the load generator 213 is in contact with the flank 207. The roller 215 is biased by means of a spring 213. A force F of the spring 213 acts in a horizontal direction on the roller 215 and presses it against the flank 207.

A housing 219 encapsulates the components of the toothing test stand. The load generator 213 is fixed in the housing 219. Furthermore, the housing 219 forms the sample holder 209. Inside the housing 219 is an oil bath 221 in which the flank 207 of the tooth sample 203 and the roller 215 of the load generator 213 are immersed. The oil lubrication present in an actual gear wheel can be simulated by the oil bath 221.

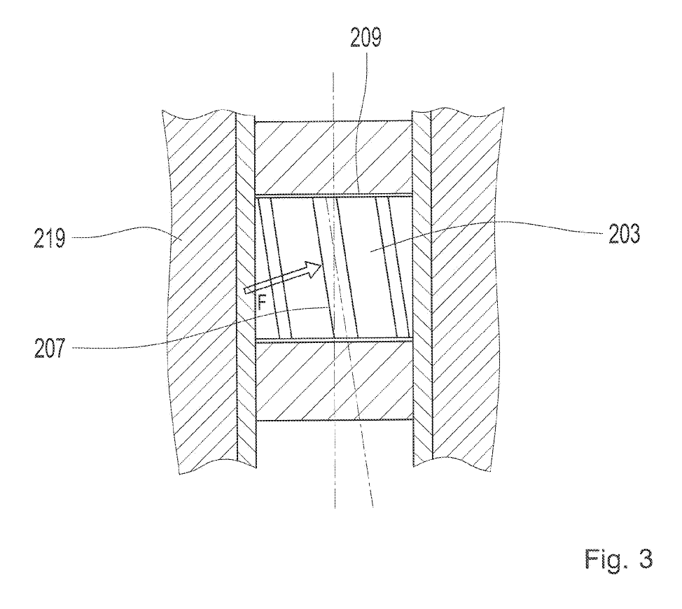

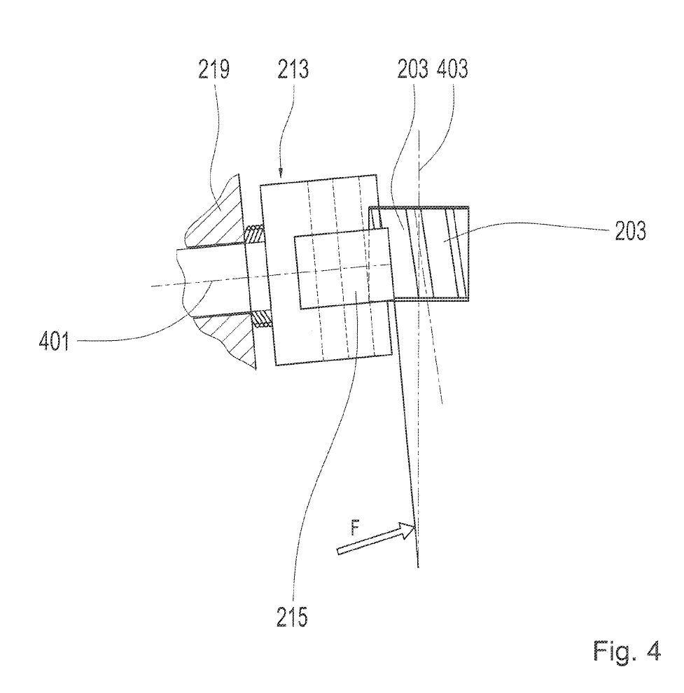

A view of the tooth sample 203 from below is shown in FIG. 3. It can be seen here that this is a section of a helical toothing. The force F acting on the flank 207 of the tooth sample 203 for testing purposes must, correspondingly, be oriented obliquely. This is achieved by a correspondingly inclined orientation of the load generator 213, as shown as in FIG. 4.

According to FIG. 4, a main axis 401 along which the roller 215 is displaceable, and in the direction of which a force can be applied accordingly, runs orthogonally to the flank 207 of the tooth sample 203. The flank 207 in turn runs anti-parallel to a main axis 403 of the toothing test stand 201. The main axis 403 is aligned parallel to an axis of rotation of the gear wheel 101 from which the tooth sample 203 has been separated. Thus, in particular, the main axis 401 of the load generator 213 and the main axis 403 of the toothing test stand 203 are not orthogonal to each other.

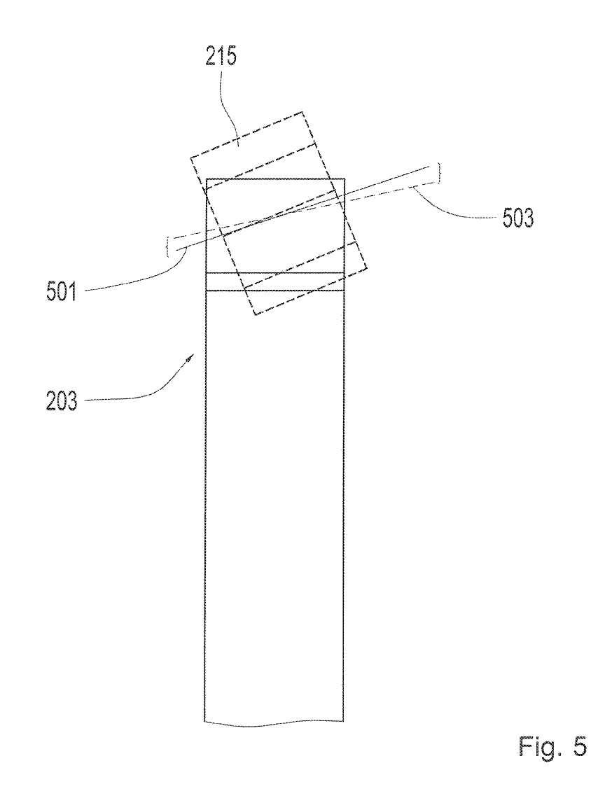

The direction of the perspective shown in FIG. 5 corresponds to the direction of the force F applied by the load generator 213. From this perspective, a rotational axis 501 of the roller 215 of the load generator 213 can be seen to interlace with respect to a meshing line 503. The meshing line 503 indicates an area in which the flank 207 of the tooth sample 203 is loaded by the roller 215. In particular, there is contact between the roller 215 and the flank 207 along the meshing line 503. As a result of the interlacing, the rotational axis 501 of the roller 215 and the meshing line 503 run anti-parallel. This causes so-called specific sliding of the roller 215. In this case, the roller 215 moves not only in a rolling fashion, but also slidably over the surface of the flank 207. This makes it possible to very exactly simulate load relationships which actually exist.

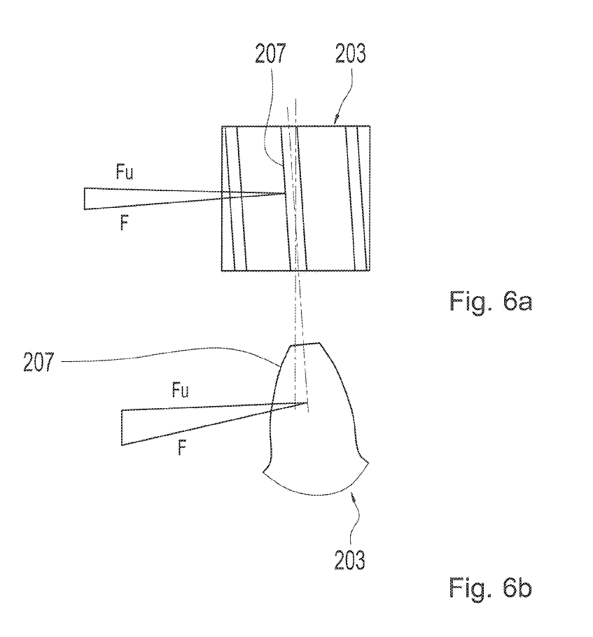

The resulting force relationships are illustrated in FIGS. 6a and 6b; a first component of a force F applied by the load generator 213 on the flank 207 acts in the flank as a normal force Fn perpendicular to the flank 207. A second component of the force F is perpendicular to Fn.

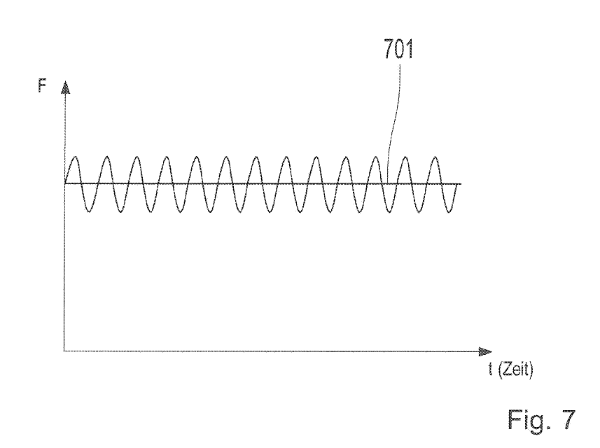

FIG. 7 illustrates the force F applied by the roller 215 to the flank 207 of the tooth sample 203 over time. Also shown is a test load 701 which is applied by the spring 217 at rest. By the up-and-down movement of the tooth sample 203, force F describes a periodic path fluctuating about the test load 701.

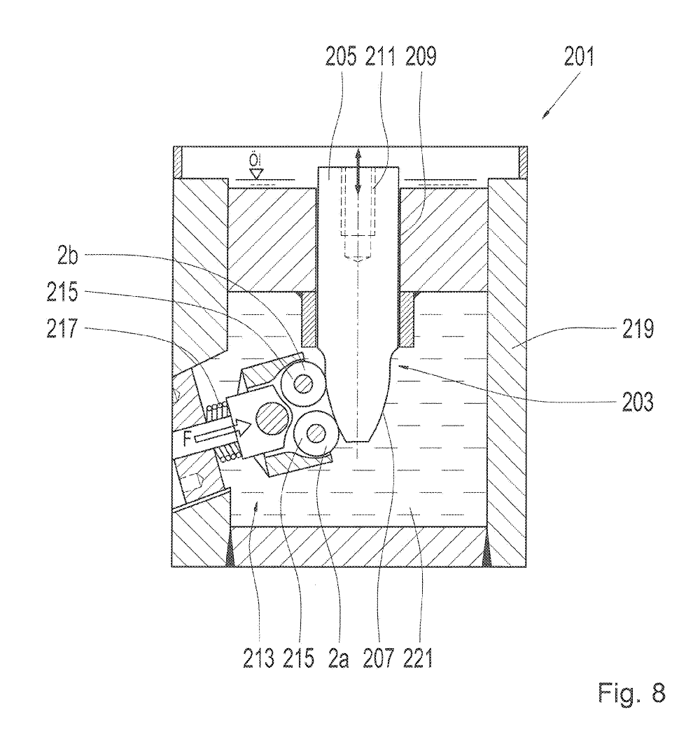

FIG. 8 shows a variant of the toothing test stand 201 with two rollers 215. Both rollers 215 abut the flank 207 of the tooth sample 203 and are loaded by the force of spring 217. In this way, a simulation of the actually prevailing load circumstances is achieved which mirrors reality.

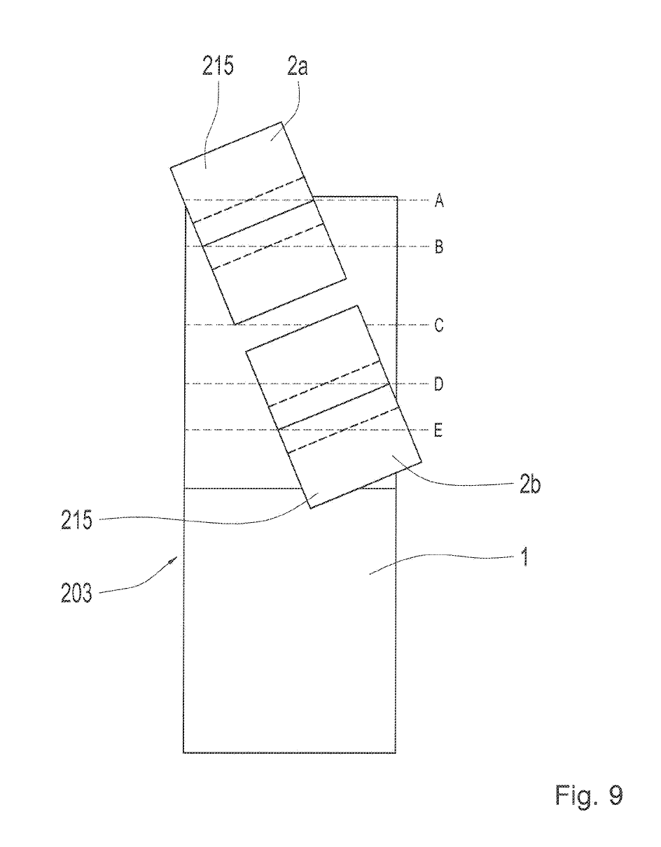

As shown in FIG. 9, the rollers 215 are, analogously to FIG. 5, also interlaced with respect to the mesh lines thereof in a dual design, so as to simulate specific sliding.

The gear wheel 101 from which the tooth sample 203 has been separated can be an internally-toothed or an externally-toothed gear wheel 101.

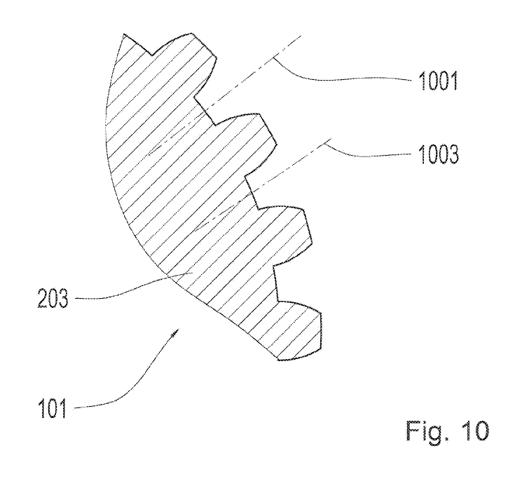

FIG. 10 shows an externally-toothed gear wheel 101. The tooth sample 203 is separated from the gear wheel 101 along a first cutting surface 1001 and a second cutting surface 1003. The first cutting surface 1001 and the second cutting surface 1003 extend in parallel to each other.

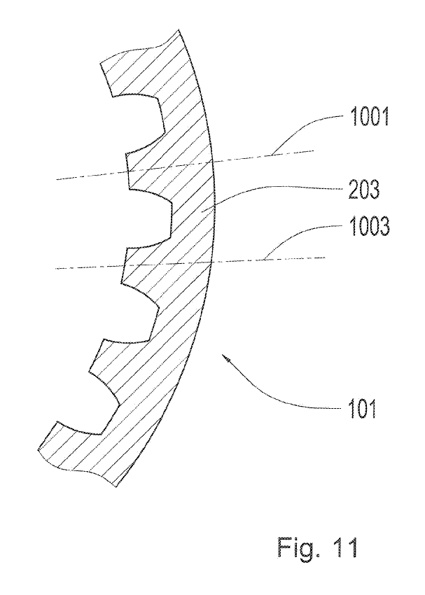

FIG. 11 analogously represents an internally-toothed gear wheel 101. The tooth sample 203 is separated from the gear wheel 101 along the first cutting surface 1001 and the second cutting surface 1003. Here, too, the first cutting surface 1001 and the second cutting surface 1003 run parallel to each other.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

101 Gear wheel
103 Punch
201 Toothing test stand
203 Tooth sample
205 Shaft
207 Flank
209 Sample holder
211 Internal thread
213 Load generator
215 Roller
217 Spring
219 Housing
221 Oil bath
401 Load generator main axis
701 Test load
1001 First cutting surface
1003 Second cutting surface

1. A toothing test stand, comprising:
a sample holder; and
a load generator,
wherein the load generator has at least one head,
wherein the sample holder is designed to hold at least one part of a single tooth sample separated from toothing of a gear wheel,
wherein the tooth sample comprises a tooth of the gear wheel,
wherein the head of the load generator bears against a flank of the tooth and applies a load to the flank,
wherein the head of the load generator is rotatably mounted, and
wherein an axis of rotation of the head of the load generator, starting from a course that runs parallel to a flank line of the flank of the tooth, rotates about a surface normal of a contact surface of the head of the load generator and the flank of the tooth.

2. The toothing test stand according to claim 1, wherein the tooth sample is configured to be translationally moved in a first direction, and wherein the head is configured to be translationally moved in a second direction.

3. The toothing test stand according to claim 2, wherein the second direction runs anti-parallel to a surface normal of a contact surface of the head and the flank, wherein the second direction runs anti-parallel to a surface normal of the flank, and wherein the head in the surface normal bears against the flank.

4. The toothing test stand according to claim 1, wherein the first direction extends radially with respect to the gear wheel.

5. The toothing test stand according to claim 2, wherein the head is braced against the flank.

6. The toothing test stand according to claim 5, wherein the load generator has at least one spring element, wherein the spring element is braced against the head.

7. The toothing test stand according to claim 3, further comprising an actuator, wherein the actuator is configured to cause an oscillating movement of the tooth sample.

8. The toothing test stand according to claim 2, wherein the load generator has at least one actuator, wherein the actuator is configured to cause an oscillating movement of the head.

9. The toothing test stand according to claim 1, wherein the head is rotationally symmetrical.

10. The toothing test stand according to claim 1, wherein the head is designed as a cylindrical roller.

11. The toothing test stand according to claim 1, wherein the load generator has at least two heads, and
wherein the at least two heads bear against the flank of the tooth and each apply a load to the flank of the tooth.

12.-14. (canceled)

15. A method for testing the toothing of a gear wheel,
the method comprising:
separating a tooth sample from the gear wheel, and
testing the tooth using the toothing test stand according to claim 1.
